(19) United States
(12) Patent Application Publication
(10) Pub. No.: US 2006/0235757 A1
(43) Pub. Date: Oct. 19, 2006

(54) Method and apparatus for improved marketing

(75) Inventor: James E. Issler, Greenwich, CT (US)

Correspondence Address: ST. ONGE STEWARD JOHNSTON & REENS, LLC, 986 BEDFORD STREET, STAMFORD, CT, 06905-5619, US

(73) Assignee: Columbia Insurance, Omaha, NE (US)

(21) Appl. No.: 11/087,155

(22) Filed: Mar. 23, 2005

(51) Int. Cl. G06Q 30/00

(52) U.S. Cl. 705/26

(57) ABSTRACT

The invention relates to a method and apparatus for improved marketing having a ticket with a first part and a second part, the first part being separable from the second part and where both parts have a customer identifier. The apparatus also includes selling area having a displayed product and a storage area having a plurality of sizes of the displayed product, each size of the plurality of sizes has a product identifier.

### FIELD OF THE INVENTION

The invention relates to a method and apparatus for improving the manner in which products are sold in a retail environment.

### BACKGROUND OF THE INVENTION

A typical retail store is arranged in a way where displayed products are available to be viewed by customers in the store and where a salesperson often interacts with the customers to answer questions and/or promote the displayed products. In the event a customer wants to try on a displayed product, such as a shirt, shoe, jacket, or other article of clothing, the salesperson normally must leave the selling area, the area where the customers and displayed products are located, to retrieve an inventoried product from the storage area for the customer to sample.

Inventoried products usually include various sizes and/or colors of the displayed products. Because numerous sizes and/or colors may be available for a single displayed product, and because the selling area may include multiple displayed products, the location of the inventoried products is usually in a storage area separable from the selling area. To put the inventoried products with the displayed products may entail enlarging the selling area to the point where it is impractical. Also, storing the numerous inventoried products with the displayed products may be unsightly.

Therefore, when the salesperson leaves the selling area, time spent on selling products is possibly reduced. Further, other selling opportunities to other customers are also possibly lost. This problem may be exacerbated when numerous customers are in the selling area and want to purchase or try on products. An undesirable outcome may be a customer who wants to sample or buy a product but decides to leave the store because of a lack of service due to the salesperson servicing other customers or being away from the selling area. In this situation, increasing the salesperson's time on the selling floor may alleviate the problem.

U.S. Pat. No. 3,420,336 to Simjian appears to relate to an article delivery system having a ticket for identifying a receiving position to deliver the article.

U.S. Pat. No. 4,852,910 to Tafer and U.S. Patent Application Publication No. 2001/0056385 to Timms seem to relate to storing articles according to color.

U.S. Pat. No. 4,472,912 appears to relate to a store display for improving the way shoes are sold. The store display seems to resemble that of a bar, where customers sit at a counter of displayed products and, if the customer wants to sample a displayed product, the salesperson behind the counter would then possibly leave the counter area to retrieve an inventoried product from the storage area.

U.S. Pat. No. 5,878,401 to Joseph and U.S. Pat. No. 6,343,276 to Barnett seem to relate to an automated way of determining an amount of products remaining in inventory.

However, the above references do no seem to relate to an improved manner for selling products where the salesperson's time in the selling area is maximized and the time away from the selling area is minimized. The above references also do not seem to relate to a manner for quickly and easily identifying and locating products, which may improve various aspects of the manner for selling products. Also, the above references do not seem to relate to a manner for quickly and easily identifying and locating customers, particularly when numerous customers are in the selling area engaged in sampling or buying products.

What is desired, therefore, is a way to sell products that minimize a salesperson's time away from the selling area. Another desire is a way to sell products that maximize the time a salesperson spends with customers. A further desire is a way to quickly identify customers and the products the customers wish to sample or purchase. Yet another desire is to quickly match the identified customers with the products the identified customers requested. Another desire is a way to retrieve products and service customers more quickly.

### SUMMARY OF THE INVENTION

It is an object of the invention to provide a manner of selling products that maximizes a salesperson's time on the selling floor with customers.

Another object of the invention is to provide a manner of selling products that quickly identifies and differentiates each customer in a group of customers so that when numerous products are retrieved from a storage area, each product of the numerous products may be given to the appropriate customer of the group of customers.

A further object is a way of more efficiently retrieving requested products for the customers.

These and other objects of the invention are achieved by an apparatus for improved marketing including a selling area having a displayed product and a ticket with a first part and a second part, the first part being separable from the second part. The first part has both a customer identifier and a product identifier for identifying the displayed product of the selling area. The apparatus also includes a storage area having a plurality of displayed products, each displayed product having a variable attribute. The customer in the selling area is identifiable by a worker possessing the first part of the ticket and a displayed product from the storage area is selectable, based on the product identifier, by a worker possessing the first part.

In some embodiments, the variable attribute is a color or a size. In other embodiments, the displayed product of the selling area has a unique product identifier corresponding to the product identifier of the first part.

In further embodiments, the storage area includes a plurality of colors for each of the plurality of displayed products and wherein the variable attribute is a color selected from the plurality of colors. Likewise, the storage area may also include a plurality of sizes for each of the plurality of displayed products and wherein the variable attribute is a size selected from the plurality of sizes.

The selling area includes a plurality of displayed products and the storage area includes a plurality of categories, each category comprising a plurality of colors and/or sizes for one displayed product. In some embodiments, each displayed product of a single category has a same product identifier. In other embodiments, each category is arranged according to the product identifier. In further embodiments, each category is arranged according to a code, such as a color, shape, alphabet, numeral, and combinations of these. In still further embodiments, the storage area has a plurality of sub areas arranged according to product identifier, color, shape, alphabet, numeral, and combinations of these.

Optionally, the invention includes a computer and software executing on the computer for displaying a ticket capable of being edited by the customer. The computer also has software executing on the computer for modifying the ticket in accordance with the received edits from the customer. The computer may also have software executing on the computer for automatically modifying the ticket to include the product identifier upon receiving an indication of the displayed product from the customer, software executing on the computer for indicating a location of a displayed product of said plurality of displayed products in the storage area, and/or software executing on the computer for indicating the location of a displayed product based on the product identifier.

In another aspect of the invention, a computerized system for improved marketing includes a computer, software executing on the computer for displaying a ticket capable of being edited by the customer, software executing on the computer for modifying the ticket in accordance with received edits from the customer, software executing on the computer for automatically modifying the ticket to include the product identifier upon receiving an indication of a displayed product from the customer, software executing on the computer for transmitting the ticket to a storage area of displayed products, and software executing on the computer for indicating a location of a displayed product of the plurality of displayed products in the storage area based on the product identifier.

In still another aspect of the invention, a method for improving marketing includes the steps of receiving a ticket from a customer where the ticket has a customer identifier and a product identifier, searching a storage area of inventoried products according to the product identifier on the ticket, and retrieving an inventoried product from the storage area based on the product identifier on the ticket. The method also includes attaching the ticket to the retrieved inventoried product and matching the customer with the retrieved inventoried product based on the customer identifier on the ticket.

The method may also include the step of displaying an electronic ticket capable of being edited by the customer. In some embodiments, the method may also include modifying the electronic ticket in accordance with received edits from the customer or automatically modifying the ticket to include the product identifier upon receiving an indication of a displayed product from the customer. A further embodiment of the method includes the step of indicating a location of a displayed product of a plurality of displayed products in the storage area based on the product identifier.

### BRIEF DESCRIPTION OF THE DRAWINGS

FIG. 1 depicts an apparatus in accordance with the invention.

FIG. 2 depicts the ticket shown in FIG. 1.

FIG. 3 depicts the storage area shown in FIG. 1.

FIG. 4 depicts another view of the storage area shown in FIG. 1.

FIG. 5 depicts the system for improved marketing shown in FIG. 1.

FIG. 6 depicts a sample computer screen of the system shown in FIG. 5.

FIG. 7 depicts a method for providing the apparatus shown in FIG. 1.

### DETAILED DESCRIPTION OF THE DRAWINGS

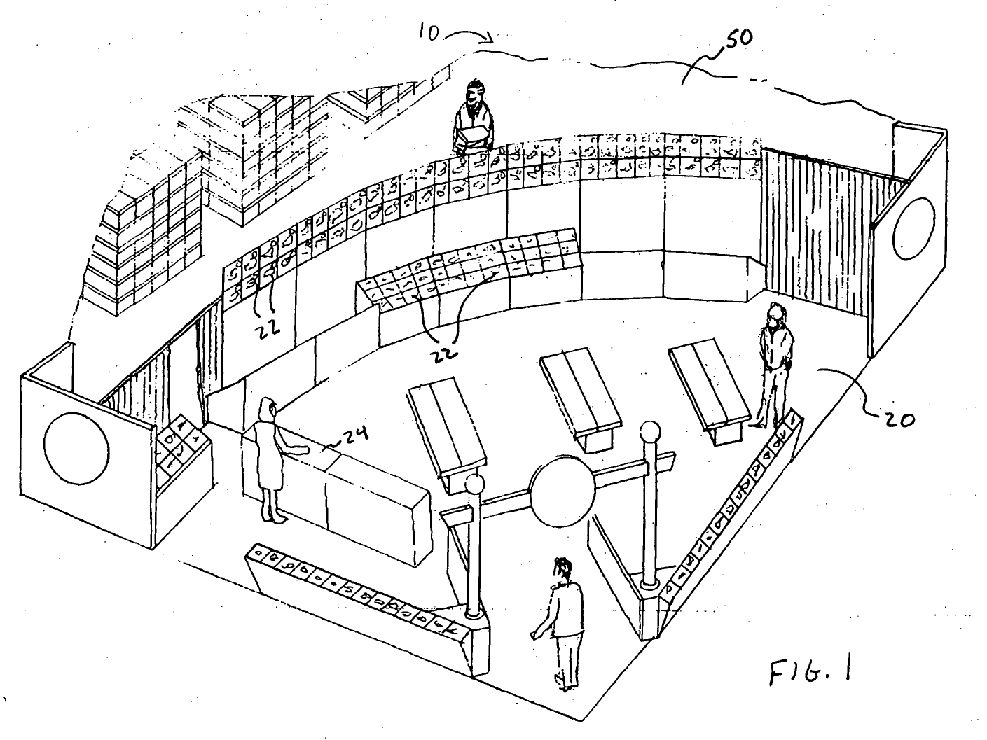

FIG. 1 depicts apparatus 10 in accordance with the invention for improved marketing of products that may be sold in a retail environment, such as a store. Apparatus 10 includes selling area 20 and storage area 50, where selling area 20 has a plurality of displayed products 22 and storage area 50 has a plurality of sizes and/or colors for each displayed product 22 of the plurality of displayed products 22.

Each displayed product 22 is a sample of a product that may be sold to a customer. Generally, although not required, each displayed product 22 varies from a next displayed product 22 because duplicating identical displayed products often do not provide any advantage but occupies limited shelf space and may be confusing as customers often would not expect identically displayed products 22 to be on display. Displayed product 22 may be a specimen or sample of the actual product to be sold or it may be a picture of the product.

The plurality of sizes and/or colors of a single displayed product 22 in storage area 50 is defined to be a category 52 of displayed product 22. Because a plurality of displayed products 22 are displayed in selling area 20, there are a plurality of categories 52 in storage area 50. In an ideal environment free from inventory shortages, there is a category 52 for each displayed product 22. Since category 52 includes various sizes and/or colors, or variable attributes, for a single displayed product 22, storage area 50 should be large enough to accommodate all categories and is often magnitudes larger than selling area 20.

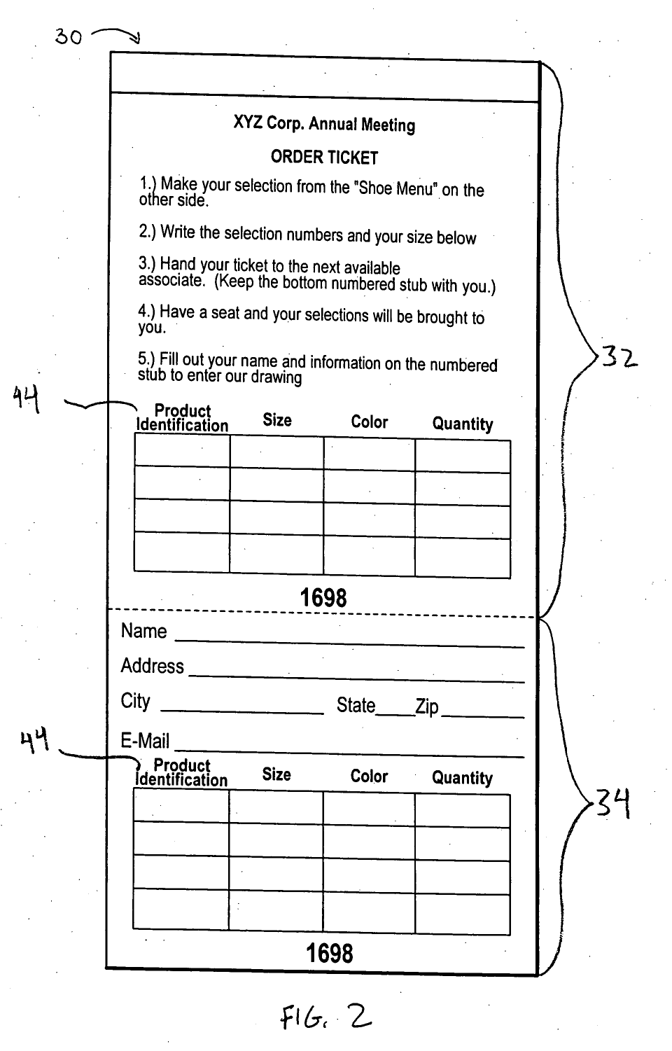

As shown in FIG. 1, dispenser 24 is in selling area 20 to dispense at least one ticket 30 for a customer to fill out and give to salesperson 26. Dispenser 24 is any table top, kiosk, or area that holds a plurality of tickets 30 for customers to use. Moreover, multiple dispensers 24 may be used in a single selling area 20, depending upon the volume of customers or size of selling area 20. Ticket 30 is more particularly depicted in FIG. 2.

FIG. 2 shows ticket 30 as having first part 32 and second part 34, where each part also has customer identifier 42. First part 32 also has areas for a customer to fill in product identifier 44, desired size, desired color, width, other variable attributes, or quantity of products to be retrieved from storage area 50.

Optionally, second part 34 may also include an area for customer to fill in product identifier 44 and his/her name or mailing address, reasons for which are described later.

Product identifier 44 corresponds with a code, whether alphabetic, numerical, or alphanumeric, that is unique to each displayed product 22. Each product identifier 44 is placed proximate to the corresponding displayed product 22. Further, each category 52, and all products stored within each category 52, are marked or identified in storage area 50 with the same product identifier 44.

Dispenser 24 may also include smaller representations of each displayed product 22, such as a small picture of each product 22, along with product identifier 44. This may be helpful if selling area 20 is large and may alleviate the need for the customer to walk back to the part of selling area 20 that contains the desired displayed product that the customer wishes to sample or purchase for the purpose of obtaining product identifier 44 of the desired displayed product.

Upon a customer filling first part 32, and optionally second part 34, the customer separates first part 32 from second part 34 and delivers first part 32 to the salesperson, who would then deliver first part 32 to an inventory personnel stationed in storage area 50. The inventory personnel's responsibility would be to retrieve the product identified by product identifier 44, size, color, width, or quantity, as the customer stated on first part 32. The delivery from the salesperson to the inventory personnel may be through all known or novel means, such as via a chute, conveyor belt, door, slide, and the like. All that is required is for the inventory personnel to retrieve the requested product and for the salesperson to remain in selling area 20 to continue to market other displayed products 22 or answer questions. The saleperson's time spent retrieving products should be minimized or eliminated.

In some situations, it is understood that in the event of a lack of personnel, the salesperson may retrieve products or the inventory personnel may act as the salesperson. Further, in other embodiments, the customer may also directly deliver first part 32 to the inventory personnel, as it is not essential that the salesperson receive first part 32 from the customer and deliver same to the inventory personnel.

Upon retrieving all products specified by product identifier 44, size, color, or quantity, as the customer stated on first part 32, the inventory personnel then delivers the retrieved product(s) and first part 32 to the salesperson. The delivery of first part 32 and retrieved product(s) from the inventory personnel to the salesperson includes the same limitations as described above for delivering first part 32 to the inventory personnel.

The salesperson then may be able to identify the customer who requested the retrieved products by announcing or displaying customer identifier 42. The customer, because he/she has retained second part 34 after giving first part 32 to the salesperson, matches the announced customer identifier 42 with customer identifier 42 on second part 34. The customer is then is able to inform the salesperson that he/she is the customer that requested the retrieved products.

The salesperson then is able to match or correspond the retrieved products with the correct customer.

As stated above, second part 34 is retained by the customer and may optionally include an area for customer to fill in product identifier 44 and his/her name or mailing address. Product identifier 44 may be useful on second part 34 for a customer who cannot remember the product he/she requested, including the customer who orders many quantities of various shoes.

For promotional purposes, the store may decide to have a raffle or drawing to entice customers to enter the store, in which case second part 34, because it includes the name, address, or other contact information, may be submitted. The customer would normally submit second part 34 for the purposes of the drawing or raffle after he/she completed the use of ticket 30 to retrieve products.

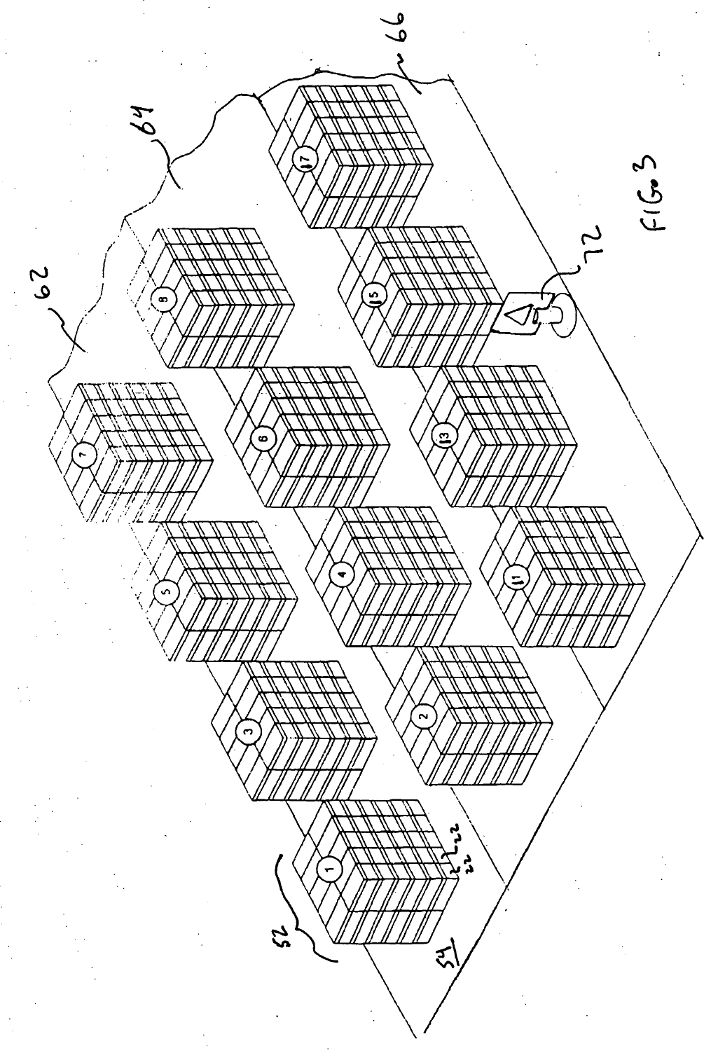

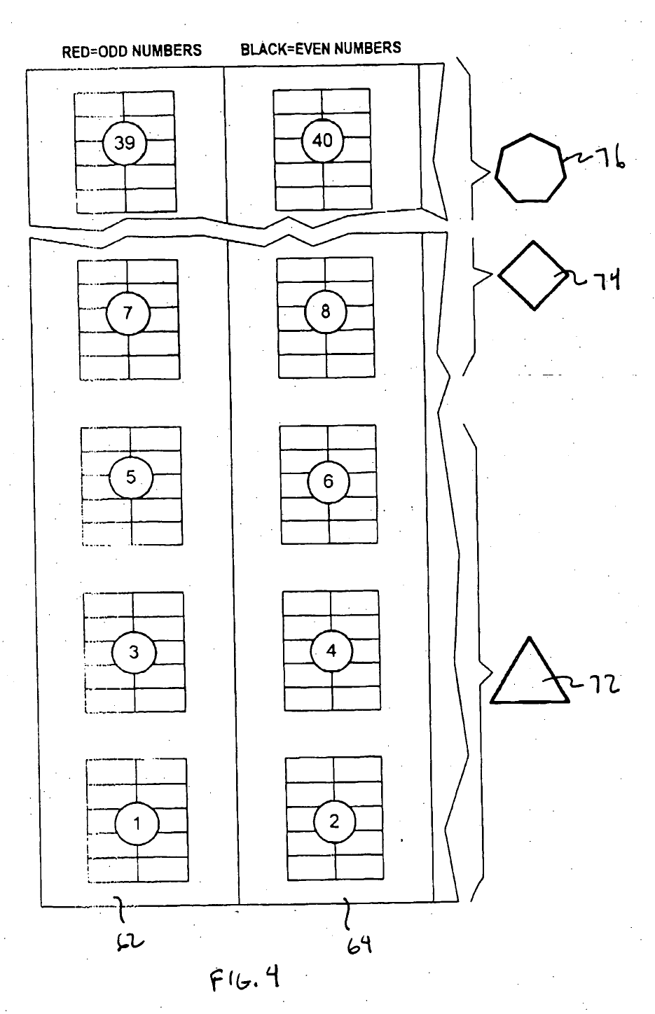

As shown in FIGS. 3 and 4, storage area 50 is organized according to category 52, where each category 52 has its own respective subarea 54 of storage area 50. All products, whether varying by size or color, having the same product identifier 44 as category 52 is placed within that category's respective sub area 54.

Where numerous categories 52 are within storage area 50, categories 52 may further be organized according to color, geometric shape, alphabet, numeral, or any combinations thereof. For example, in addition to organizing categories 52 by product identifier 44, the color white may indicate left side 62 of storage area 50, the color green may indicate middle 64 of storage area 50, and purple may indicate right side 66 of storage area 50. Still further, a triangle shape may indicate fore area 72 of storage area 50, diamond shape may indicate intermediate area 74 of storage area 50, and a polygon shape may indicate far area 76 of storage area 50.

In this effort, where product identifier 44 is a numeral and where categories 52 are numbered in increasing fashion from fore area 72 to far area 76 and where odd numbers happen to fall within left side 62 or even numbers fall within middle 64, the inventory personnel may quickly and easily determine the general area of storage area 50 to direct his/her search based upon product identifier 44. This is because, based on the organization of storage area 50 described in this paragraph, product identifier 44 indicates whether or not the product is in the fore, intermediate, far, left side, middle, and/or right side of storage area 50. This is particularly useful where storage area 50 is large.

In a further embodiment, product identifier 44 would also include color, geometric shape, alphabet, numeral, and combinations thereof, whereupon locating the product in storage area 44 would be even easier than if product identifier 44 is simply a numeral. However, in the event selling area 20 or storage area 50 is rearranged, this would make inventorying products more complex.

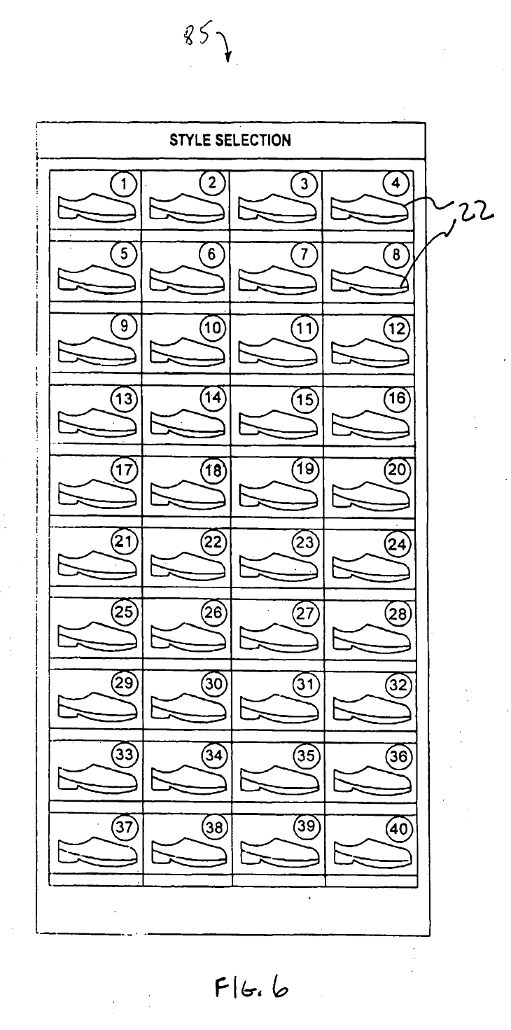

In a further embodiment, apparatus 10 is automated in part or in whole. Instead of a hard copy, ticket 30 may be an electronic copy displayed on a computer or kiosk where the customer may input product identifier 44, desired size, desired color, or quantity of products to be retrieved from storage area 50. In some embodiments, when the customer fills out product identifier 44 on ticket 30, series 85 of electronic pictures representing all displayed products 22 may appear on the computer (see FIG. 6) and the customer selects, or clicks, upon the image representing the desired product 22 to sample or purchase, and the computer automatically fills in product identifier 44 on ticket 30. This may facilitate and reduce human error when filling out ticket 30 because the customer sees the product 22 and need not remember the particular identifier 44, especially if identifier 44 includes alphabets, numerals, colors, geometric shapes, and the like. The customer may then print out ticket 30 and deliver first part 32 to the salesperson or inventory personnel. In these embodiments, dispenser 24 may be a printer.

Alternatively, the customer may transmit ticket 30 or first part 32 electronically and directly to the inventory personnel, thereby bypassing the salesperson. The customer may then print out second part 34 or ticket 30 for his/her own record. Where second part 34 may be utilized as part of a raffle or drawing, the customer may electronically transmit second part 34 to be eligible for the raffle or drawing in addition to printing it out.

In the event a requested displayed product is not available in storage area 50, the inventory personnel may indicate this on first part when first part 32 is returned to the customer, such as simply hand marking first part 32. In an automated environment, an electronic message may be sent to a sales person who would communicate the content to the customer.

In a further embodiment, the customer may be notified by the computer immediately subsequent to the customer requesting the displayed product. If the computer is in communication with a database that contains the inventory level, indicating colors and sizes, of displayed products, the computer may be able to check to quickly determine if a displayed product requested by a customer is available, or in storage area 50. After checking, the computer would send an electronic notification to the computer the customer is using.

In another further embodiment, where inventoried products are categorized according to alphabet, numeral, color, geometric shape, and combinations thereof, the inventory of such categorizations may be electronically stored on a central database, whereupon the computer in selling area 20 for filling out tickets 30 is also updated as inventory is updated.

Also, rearranging selling area 20 or storage area 50 may not be as monotonous as in a non-automated or non-computerized environment since inventory and storage information may easily be copied, deleted, or moved on a microprocessor.

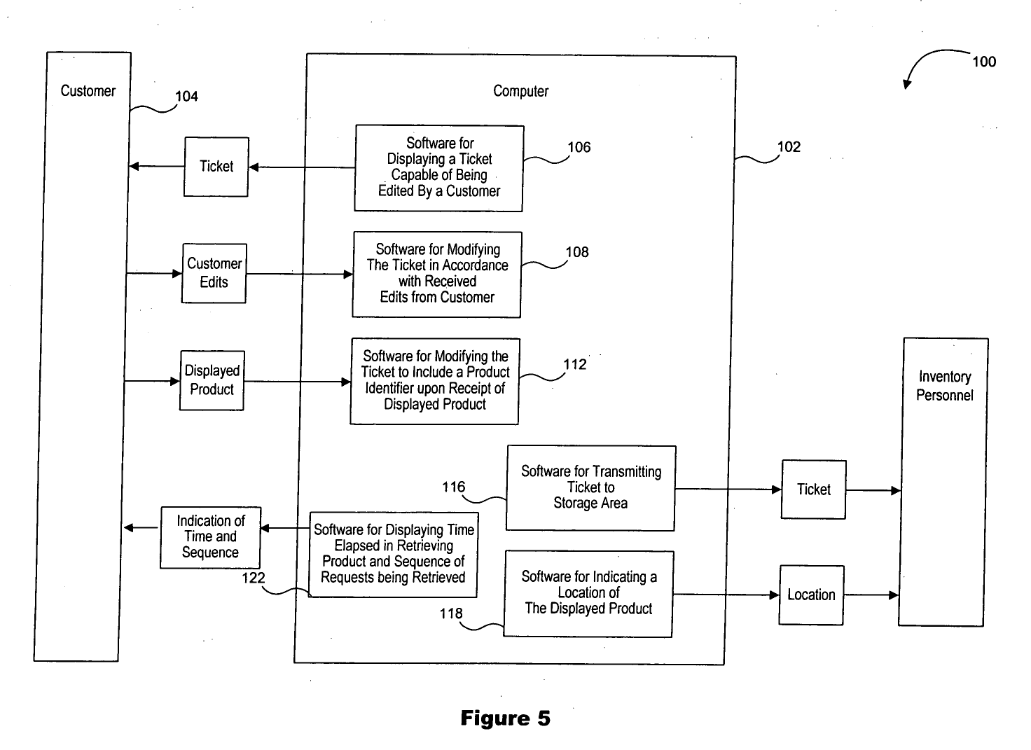

In another aspect of the invention shown in FIG. 5, system 100 for improved marketing may be provided. System 100 includes computer 102, software 106 executing on computer 102 for displaying a ticket capable of being edited by customer 104, and, after the customer makes any edits, software 108 executing on computer 102 for modifying the ticket in accordance with received edits from the customer.

System 100 further prompts the customer to enter the product identifier in order to identify the shoe to be retrieved, whereupon software 112 executing on computer 102 automatically modifies the ticket to include the product identifier upon receiving an indication of a displayed product from the customer.

System 100 also includes software 116 for transmitting the ticket to a storage area of displayed products so that an inventory personnel may retrieve the requested product based upon the product identifier. In some embodiments, software 116 for transmitting the ticket occurs automatically without user intervention when modifications to the ticket are completed, either by a predetermined pause indicating no more changes are to take place or by the product identifier being received by the customer.

System 100 also includes software 118 executing on the computer for indicating a location of the displayed product of the plurality of displayed products in the storage area based on the product identifier. In this fashion, the inventory personnel may be informed not only of the product to be retrieved, but also where it may be located so that retrieval is facilitated. In some embodiments, the inventory personnel has access to a computer that receives the ticket and indicates the location of the displayed product in the plurality of displayed products, which is a single category as described above. The software may indicate the location based upon the product identifier and, secondarily, size or color.

In a further embodiment of the invention, system 100 may optionally include software 122 for displaying the time elapsed, perhaps from an overhead monitor, from when the customer submits the ticket to when the customer receives his/her requested product. Moreover, the display may also include the order in which the customer will be served where various customers would be prioritized based upon the order of ticket submissions. When a ticket is submitted, either manually or electronically, the customer's name appears on the display and a counter begins counting. When the requested product is retrieved, the product may be scanned by an inventory personnel or salesperson prior to handing the requested product to the customer, at which point the counter stops and the customer's name would be removed from the display. In this fashion, waiting customers have an indication of when they will be served based on the sequence of names displayed and the customers have an indication as to how long they have been waiting.

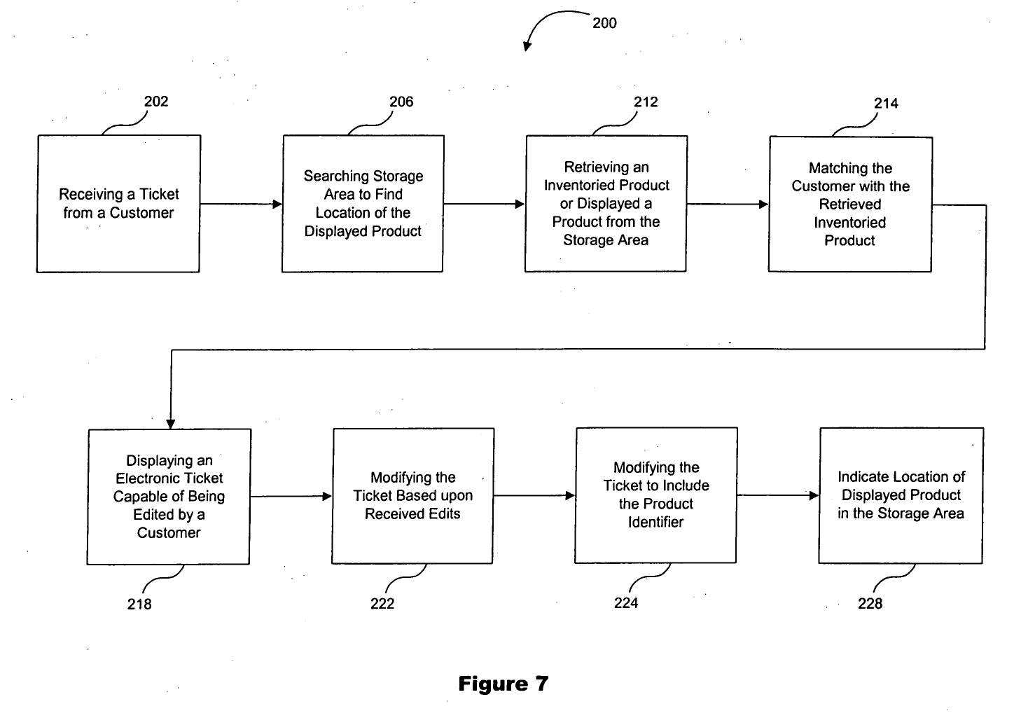

In another aspect of the invention shown in FIG. 7, method 200 is provided for improving marketing, including the steps of receiving 202 a ticket from a customer, where the ticket has a customer identifier and product identifier, and searching 206 a storage area of inventoried products according to the product identifier on the ticket. In a computerized environment, searching 206 may be performed by the computer to find the general location of the product and the location may be displayed on the computer screen for the inventory personnel to view and search. In a non computerized environment, searching 206 may be performed by the inventory personnel by any of the above described manners for searching the storage area.

Method 200 also includes the steps of retrieving 212 an inventoried product, which is a requested product or desired displayed product of the plurality of displayed products, from the storage area based on the product identifier on the ticket and attaching the ticket to the retrieved inventoried product when sending the retrieved inventoried product to the customer. Method 200 also includes the step of matching 214 the customer with the retrieved inventoried product based upon the customer identifier on the ticket.

It is understood that some or all of the above steps may be performed by a person or computer and that some or all of the above steps may be automatically performed without user intervention. In some embodiments, method 200 displays 218 an electronic ticket capable of being edited by the customer and, based upon received edits from the customer, modifies 222 the electronic ticket. As suggested above, method 200 may automatically modify 224 the ticket to include the product identifier upon receiving an indication of a displayed product from the customer.

Moreover, method 200 may indicate 228 the location of a displayed product of a plurality of displayed products in the storage area based on the product identifier. Method 200 may also include ways for automating or partly automating displayed products to and from selling area 20 and/or storage area 50, such as a conveyor belt.

1. An apparatus for improved marketing where a customer is easily identified by a worker and the worker more efficiently retrieves the customer's request for a product, comprising:
a selling area having a displayed product;
a ticket having a first part and a second part, said first part being separable from said second part;
said first part having a customer identifier;
said first part further including a product identifier for identifying said displayed product of said selling area;
a storage area having a plurality of displayed products;
each displayed product of said storage area having a variable attribute;
wherein a customer in said selling area is identifiable by a worker possessing said first part of said ticket; and
wherein a displayed product from said storage area is selectable, based on said product identifier, by a worker possessing said first part of said ticket.

2. The apparatus according to claim 1, wherein said variable attribute is a color.

3. The apparatus according to claim 1, wherein said variable attribute is a size.

4. The apparatus according to claim 1, wherein each displayed product of said selling area has a unique product identifier corresponding to said product identifier of said first part.

5. The apparatus according to claim 1, said storage area further includes a plurality of colors for each of said plurality of displayed products and wherein said variable attribute is a color selected from said plurality of colors.

6. The apparatus according to claim 1, said storage area further includes a plurality of sizes for each of said plurality of displayed products and wherein said variable attribute is a size selected from said plurality of sizes.

7. The apparatus according to claim 1, said selling area further includes a plurality of displayed products.

8. The apparatus according to claim 1, said storage area further includes a plurality of categories, each category comprising a plurality of sizes or colors for one displayed product.

9. The apparatus according to claim 8, wherein each displayed product of a single category has a same product identifier.

10. The apparatus according to claim 8, wherein each category is arranged according to said product identifier.

11. The apparatus according to claim 8, wherein each category is arranged according to a code selected from the group consisting of color, shape, alphabet, numeral, and combinations thereof.

12. The apparatus according to claim 1, wherein said storage area includes a plurality of sub areas arranged according to product identifier, color, shape, alphabet, numeral, and combinations thereof.

13. The apparatus according to claim 1, further comprising a computer and software executing on said computer for displaying a ticket capable of being edited by the customer.

14. The apparatus according to claim 13, further comprising a computer and software executing on said computer for modifying the ticket in accordance with the received edits from the customer.

15. The apparatus according to claim 13, further comprising a computer and software executing on said computer for automatically modifying the ticket to include said product identifier upon receiving an indication of the displayed product from the customer.

16. The apparatus according to claim 1, further comprising a computer and software executing on said computer for indicating a location of a displayed product of said plurality of displayed products in the storage area.

17. The apparatus according to claim 16, further comprising a computer and software executing on said computer for indicating the location of a displayed product based on said product identifier.

18. A system for improved marketing, comprising:
a computer;
software executing on said computer for displaying a ticket capable of being edited by the customer;
software executing on said computer for modifying the ticket in accordance with received edits from the customer;
software executing on said computer for automatically modifying the ticket to include a product identifier upon receiving an indication of a displayed product from the customer;
software executing on said computer for transmitting the ticket to a storage area of displayed products; and
software executing on said computer for indicating a location of a displayed product of said plurality of displayed products in the storage area based on the product identifier.

19. A method for improved marketing, comprising the steps of:
receiving a ticket from a customer, the ticket having a customer identifier and a product identifier;
searching a storage area of inventoried products based on the product identifier on the ticket;
retrieving an inventoried product from the storage area based on the product identifier on the ticket;
attaching the ticket to the retrieved inventoried product; and
matching the customer with the retrieved inventoried product based on the customer identifier on the ticket.

20. The method according to claim 19, further comprising the step of displaying an electronic ticket capable of being edited by the customer.

21. The method according to claim 20, further comprising the step of modifying the electronic ticket in accordance with received edits from the customer.

22. The method according to claim 20, further comprising the step of automatically modifying the ticket to include the product identifier upon receiving an indication of a displayed product from the customer.

23. The method according to claim 22, further comprising the step of indicating a location of a displayed product of a plurality of displayed products in the storage area based on the product identifier.
